(19) United States
(12) Patent Application Publication
(10) Pub. No.: US 2019/0393743 A1
(43) Pub. Date: Dec. 26, 2019

(54) DIRECT CURRENT MOTOR SYSTEM AND METHOD OF USE

(71) Applicant: David Clayton Henderson, Lousville, KY (US)

(72) Inventor: David Clayton Henderson, Lousville, KY (US)

(21) Appl. No.: 16/100,385

(22) Filed: Aug. 10, 2018

Related U.S. Application Data
(60) Provisional application No. 62/688,493, filed on Jun. 22, 2018.

(51) Int. Cl. H02K 1/17; H02K 1/27

(52) U.S. Cl. CPC H02K 1/17; H02K 2205/00; H02K 2201/00; H02K 1/274

(57) ABSTRACT

A direct current motor includes a base and a top forming a channel; a field ring level positioned between the base and the top, the field ring level having primary field shaping magnets disposed therein at an angle; a core positioned within the channel; and a brush insert disposed within the channel; the field ring level creates a magnetic field that acts like a crashing wave, wherein the magnetic field is to spin a single magnet core.

### BACKGROUND

### 1. Field of the Invention

The present invention relates generally to direct current (DC) motors and more specifically to an ultra-efficient direct current motor that forms a magnetic field that acts like a crashing wave.

### 2. Description of Related Art

DC motors are well known in the art and are effective means to convert direct current electrical energy into mechanical energy. DC motors can use magnetic force and can be used in a wide variety of applications, therefore it is desirable to create a DC motor that is ultra-efficient, as is an object of the present invention.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an exploded view of a direct current (DC) motor in accordance with a preferred embodiment of the present application;

FIG. 2 is a top view of the DC motor of FIG. 1 with the top removed for clarity;

FIG. 3 is a top view of a first embodiment of a core of FIG. 2;

FIG. 4 is a top view of a second embodiment of a core of FIG. 2;

FIG. 5 is an oblique view of a top of the DC motor of FIG. 1;

FIG. 6 is a top view of a base of the DC motor of FIG. 1;

FIG. 7 is an oblique view of a spacer of the DC motor of FIG. 1;

FIG. 8 is a top view of a brush insert of the DC motor of FIG. 1; and

FIG. 9 is a top view of a field ring level for holding a plurality of magnets of the DC motor of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application provides a direct current motor that is ultra-efficient by forming a magnetic field that acts like a crashing wave. The field ring of the DC motor creates a magnetic field that can spin a single magnet core 359 degrees before bouncing back. The bounce back is overcome via an electromagnetic pulse. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

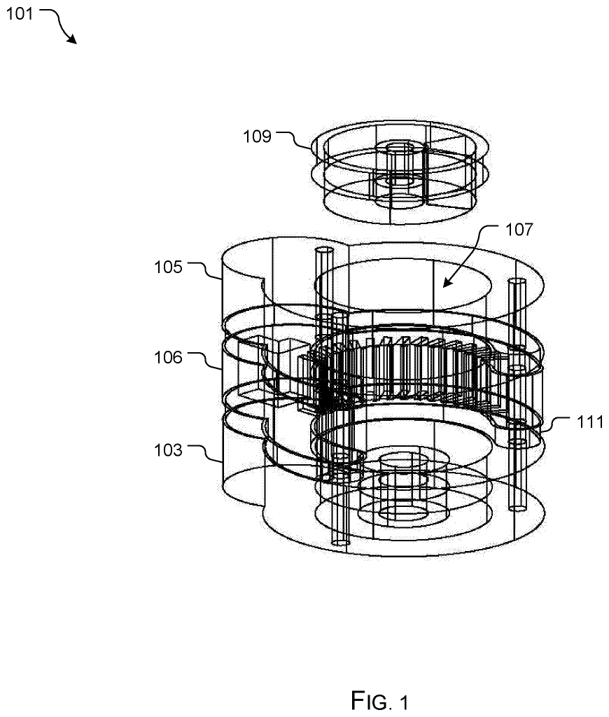

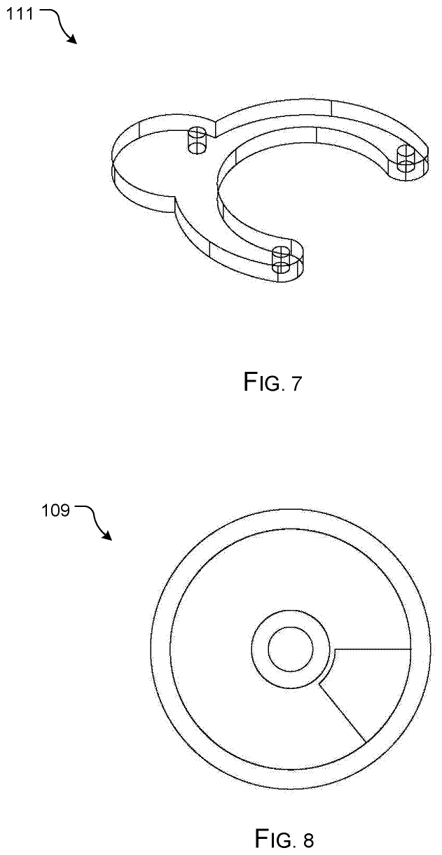

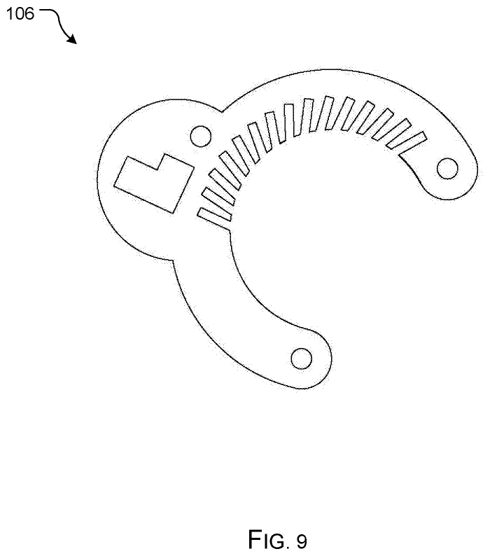

Referring now to the drawings wherein like reference characters identify corresponding or similar elements throughout the several views, FIGS. 1-9 depicts various views of the components of a direct current (DC) motor 101 in accordance with a preferred embodiment of the present application. In the preferred embodiment, the motor system discussed herein could be utilized to induce the revolution of a shaft; however, it should be appreciated that the motor system could be utilized to create energy from the revolution of a shaft or the like and should not be narrowly tailored in scope and protection to merely rotating a shaft.

In the contemplated embodiment, motor 101 includes a base 103 and a top 105 with a field ring level 106 positioned therebetween and forming a channel 107. Further included is a brush insert 109 and a core 201. In the preferred embodiment, a spacer 111 is further included between base 103 and field ring level 106.

It should be appreciated that the motor 101 provides one or more of the following features: (1) The field ring level having the diameter of Pi provides for an efficient forward advance force; (2) an improved entry and exit pressure of the base core (3) a field composed of 15 magnets having a relative position of 9 degrees between each subsequent magnet; (4) a 137 degree continuous forward attraction to move a core around the axis of a shaft; (5) a secondary jump assist to enable an efficient transition from the front edge of the field to a back thereof; (6) the primary field shaping the field ring level's magnets being at an equilateral triangle angle.

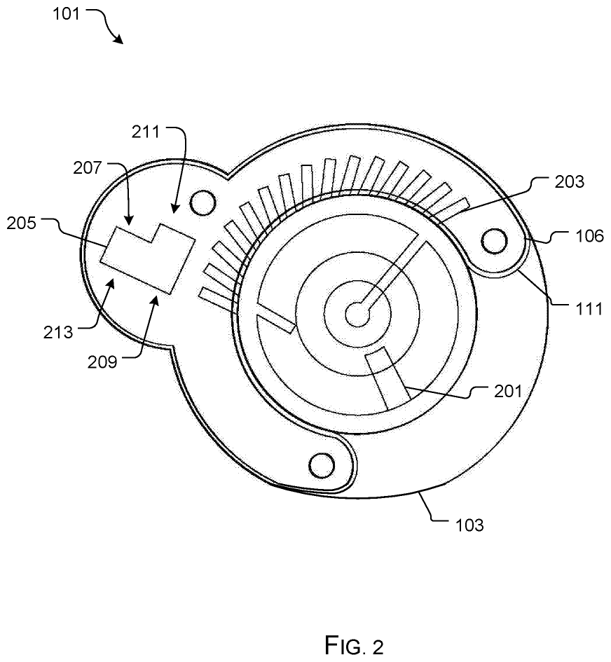

As shown in FIG. 2, the field ring level 106 includes a plurality of primary field shaping magnets 203. It should be appreciated that in the preferred embodiment, there are 15 magnets having a relative position of 9 degrees between each subsequent magnet, however, alternative embodiments could include slight modifications.

As further shown, field ring level 106 includes secondary jump assist magnets 205 being positioned with north ends 207, 209 and south ends 211, 213.

It should be appreciated that one of the unique features believed characteristic of the present application is the arrangement of the field inducing magnets and the use of secondary jump assist magnets to create an ultra-efficient DC motor. It should be appreciated that Secondary Jump Assist Magnets pull the front edge of the field around the backside greatly reducing the entry pressure and increasing the exit pressure.

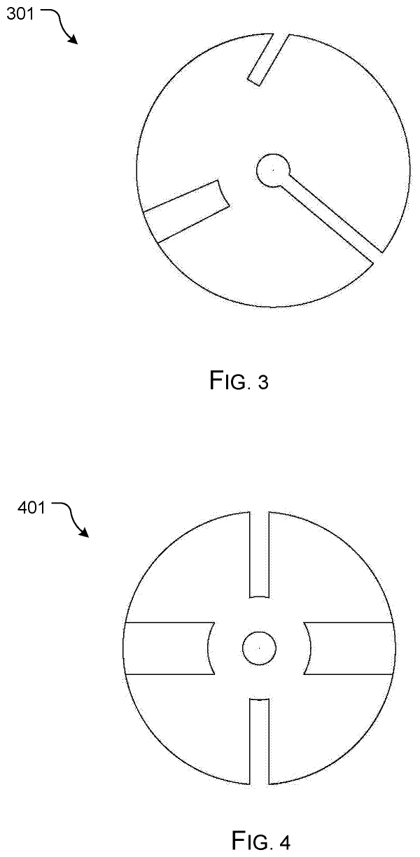

It should be appreciated that the motor can be used for different purposes just by switching out cores. In FIGS. 3 and 4, two embodiments of the core 301, 401 are shown. It should be appreciated that the core 301 includes a permanent magnet/single electromagnetic core. This embodiment contains a permanent magnet the same size as all other permanent magnets along the same triangle line as the 15 magnets around the base, and an electromagnet roughly the same size as the permanent magnets but in an orientation shown in the diagram. This is used for High torque low speed (3300 rpm−20 v/2.5 a).

Core 401 is a double electromagnetic core. Two electromagnets that alternate jumping through 50 degree activation pads on cap. Used for high speed low torque (7000 rpm−20 v/2.5 a).

In the preferred embodiment, all electromagnets have a 21/32″× 3/16″×⅛″ thick steel core wrapped with 150 windings of 22 gauge wire. This is powered by 20V/2.5 A pulsed across 50 degees. Currently the timing is controlled by brushes (not shown) mounted on top of the core that make contact with powered strips on the base cap. The electromagnets were designed to use the least amount ferrous material. The reduction of ferrous material in the core allows it to turn with minimum attraction when not in the powered areas. The residual charge in the electromagnets help to move the core forward to the powered position. It should be appreciated however that alternative embodiments can include alternative materials.

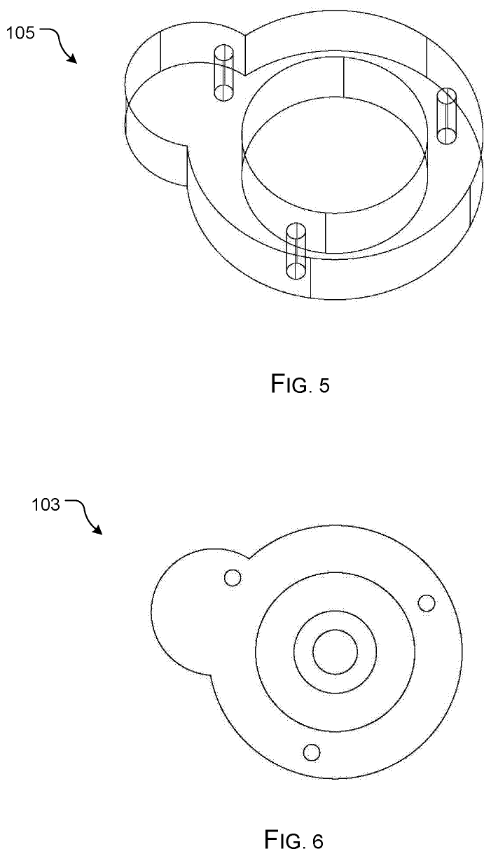

In FIGS. 5-9, the top 105, base 103, spacer 111, brush insert 109, and field ring level 106 are shown in detail for better clarity.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A direct current motor comprising:
a base and a top forming a channel;
a field ring level positioned between the base and the top, the field ring level having:
a plurality of primary field shaping magnets disposed therein at an angle;
a core positioned within the channel; and
a brush insert disposed within the channel;
wherein the field ring level creates a magnetic field that acts like a crashing wave, wherein the magnetic field is configured to spin a single magnet core.

2. The direct current motor of claim 1, further comprising:
a spacer positioned between the base and the field ring level.

3. The direct current motor of claim 1, wherein the field ring level further comprises a secondary jump assist magnet.

4. The direct current motor of claim 1, wherein the plurality of primary field shaping magnets are fifteen magnets having a relative position of nine degrees between each subsequent magnet.
